(19) United States
(12) Patent Application Publication
(10) Pub. No.: US 2012/0164886 A1
(43) Pub. Date: Jun. 28, 2012

(54) LOWER PROFILE ELECTRICAL CONNECTOR ASSEMBLY

(75) Inventors: DAVID KO, Fullerton, CA (US); CHANG-MAO LI, Kunshan (CN)

(73) Assignee: HON HAI PRECISION INDUSTRY CO., LTD., New Taipei (TW)

(21) Appl. No.: 13/335,244

(22) Filed: Dec. 22, 2011

(30) Foreign Application Priority Data
Dec. 22, 2010 (CN) 201020674466.7

(51) Int. Cl. H01R 24/28

(52) U.S. Cl. 439/626

(57) ABSTRACT

An electrical connector assembly comprises: a housing, a plurality of conductive terminals received in the housing and arranged in two rows, each conductive terminal defining a front mating portion, a retaining portion retained in the housing, and an exposing portion located behind the housing, a PCB electrically connected to the conductive terminals, and having a number of through holes through an upper and a lower surfaces thereof; a metal shell enclosing the housing and the PCB; and a cable electrically connected to the PCB. At least a row of conductive terminals are bent and pass through the through holes, and two rows of exposing portions of the conductive terminals are soldered on a surface of the PCB.

### FIELD OF THE INVENTION

The present invention relates to an electrical connector assembly, and more particularly to an electrical connector assembly having two rows of conductive terminals soldered on a surface of a printed circuit board.

### DESCRIPTION OF PRIOR ART

Developed by Sony, Hitachi, Thomson (RCA), Philips, Matsushita (Panasonic), Toshiba and Silicon Image, the High-Definition Multimedia Interface (HDMI) has emerged as the connection standard for HDTV and the consumer electronics market. HDMI is the first digital interface to combine uncompressed high-definition video, multi-channel audio and intelligent format and command data in a single digital interface. An electrical connector assembly in accordance with HDMI standard can be connected with personal computers, set top box, televisions, etc, and used for audio and video signal transmission via a same cable.

Recently, a printed circuit board (PCB) is assembled in a HDMI connector assembly for stabilizing the transmission signal. Due to a plurality of conductive terminals are arranged in two rows in this type connector assembly, the printed circuit board is usually located between two rows of conductive terminals, a row of conductive terminals is soldered on an upper surface of the PCB and another row of conductive terminals is soldered on a lower surface of the PCB. So, a number of soldered joints are higher than the surface of the conductive terminals on the upper and lower surface of the PCB. It is feasible of the tradition HDMI connector. However, the height of solder joints on two surfaces has hindered the tradition HDMI connector more miniature. As the same time, the conductive terminals need to be soldered on two surface of the PCB, if two row of conductive terminals need to be soldered on two surface of the PCB, it is need to be operated at least twice. The method is that reduce the efficiency of production.

As discussed above, an improved electrical connector assembly overcoming the shortages of existing technology is needed.

### SUMMARY OF THE INVENTION

Accordingly, an object of the present invention is to provide a lower profile electrical connector assembly having an improved method that a plurality of conductive terminals soldered on a PCB.

In order to achieve the above-mentioned objects, an electrical connector assembly comprises: a housing, a plurality of conductive terminals received in the housing and arranged in two rows, each conductive terminal defining a front mating portion, a retaining portion retained in the housing, and an exposing portion located behind the housing, a PCB electrically connected to the conductive terminals, and having a number of through holes through an upper and a lower surfaces thereof; a metal shell enclosing the housing and the PCB; and a cable electrically connected to the PCB. At least a row of conductive terminals are bent and pass through the through holes, and two rows of exposing portions of the conductive terminals are soldered on a surface of the PCB.

Other objects, features and advantages of the invention will be apparent from the following detailed description taken in connection with the accompanying drawings.

### BRIEF DESCRIPTION OF THE DRAWINGS

FIG. 1 is a perspective view of an electrical connector assembly in accordance with the present invention;

FIG. 2 is a partially assembled, perspective view of the electrical connector assembly shown in FIG. 1;

FIG. 3 is an explored, perspective view of the electrical connector assembly shown in FIG. 1;

FIG. 4 is similar to FIG. 3, but viewed from another aspect;

FIG. 5 is an assembled, perspective view of a plurality of conductive terminals, a housing and a printed circuit board of the electrical connector assembly shown in FIG. 5; and

FIG. 6 is a cross section view of the electrical connector assembly of FIG. 1 taken along line 6-6.

### DETAILED DESCRIPTION OF PREFERRED EMBODIMENTS

Reference will now be made to the drawing figures to describe the present invention in detail.

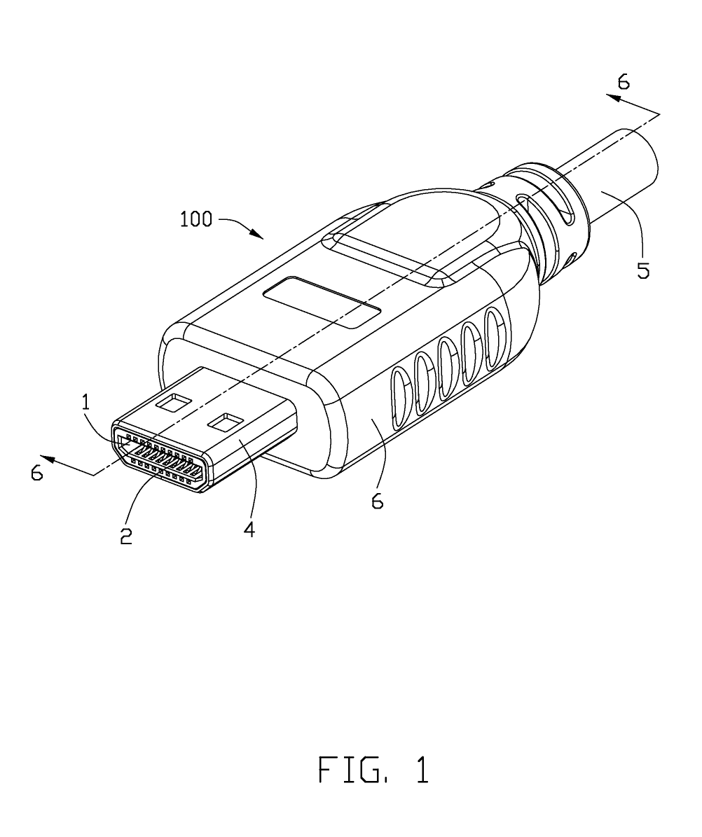

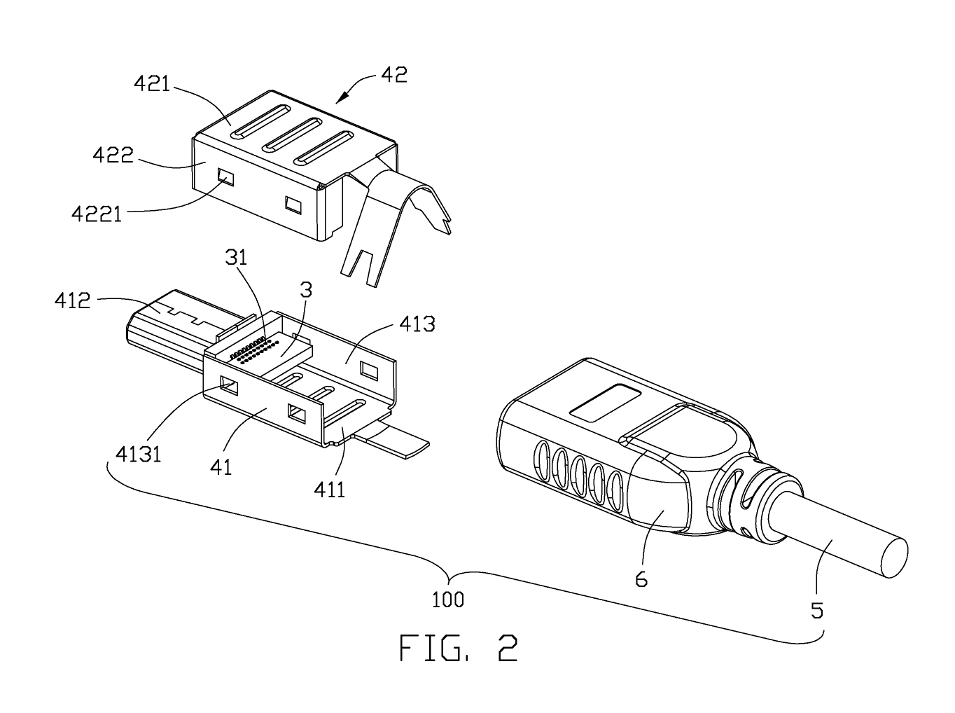

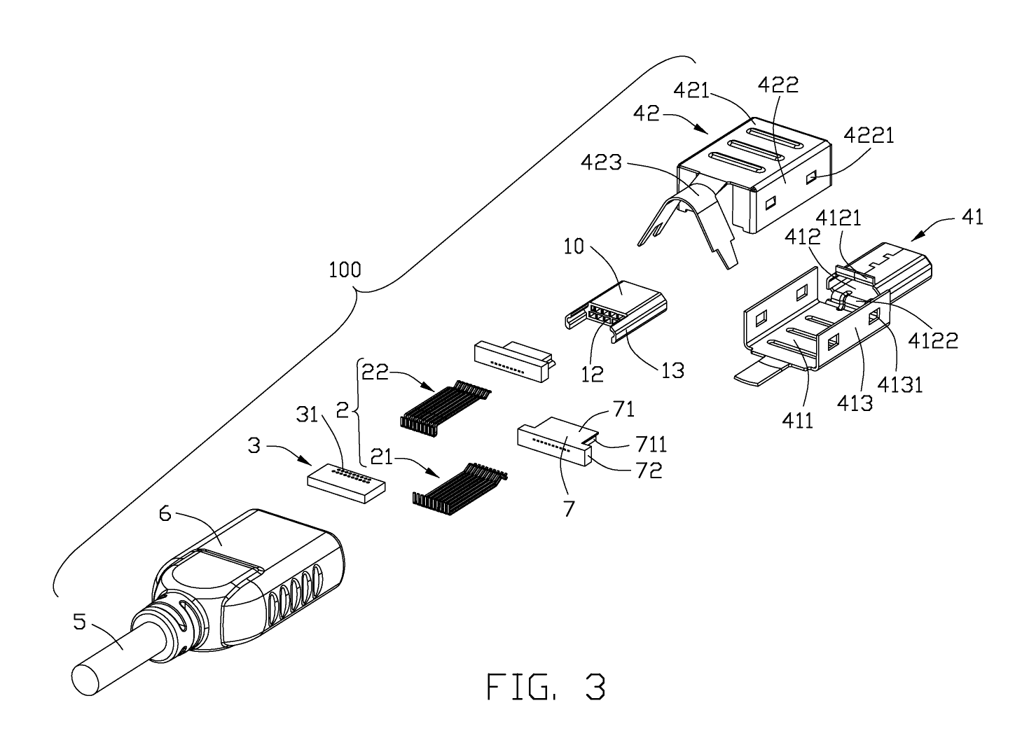

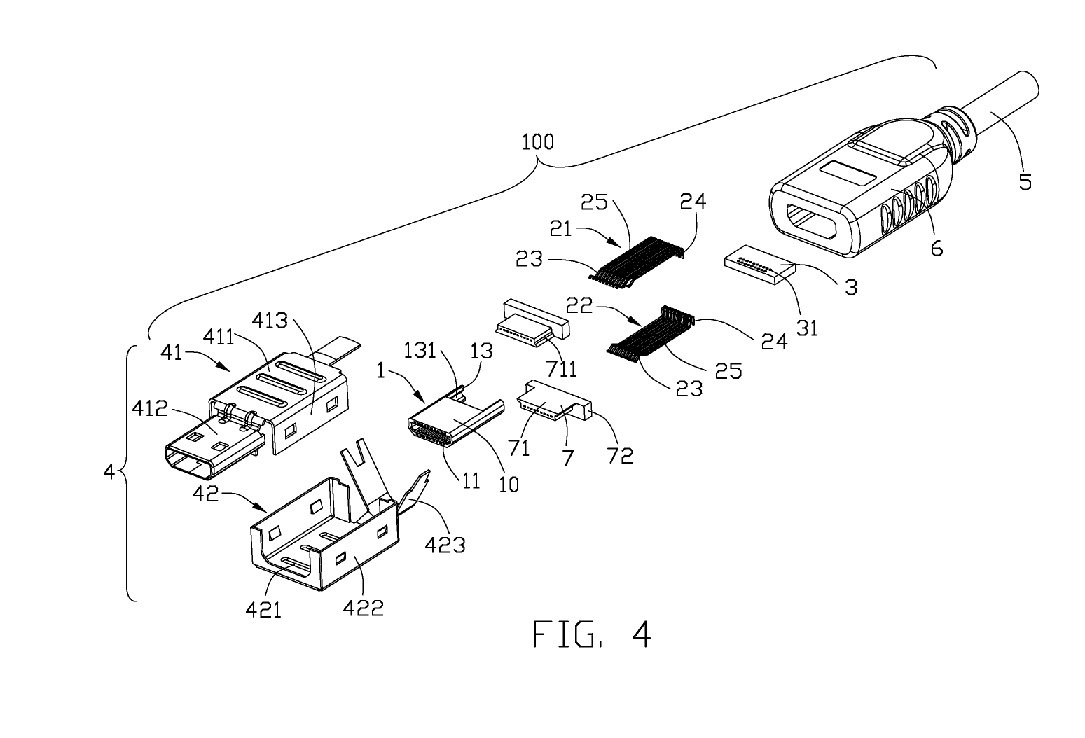

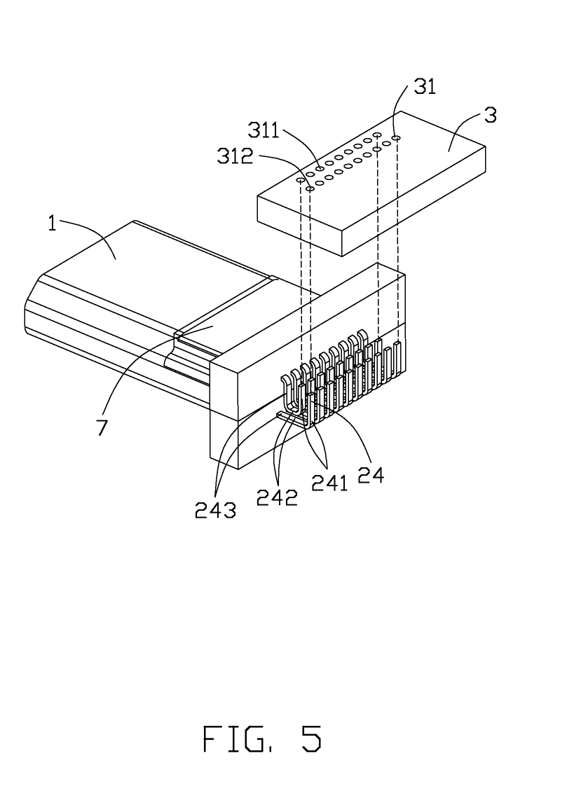

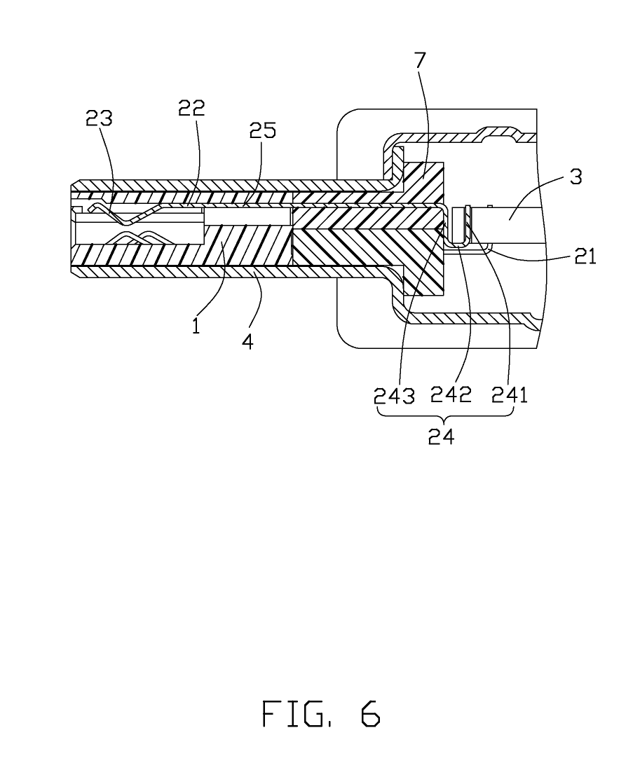

Referring to FIGS. 1 to 6, an electrical connector assembly 100 in accordance with the present invention comprises a housing 1, a plurality of conductive terminals 2 received in the housing 1, a printed circuit board (PCB) 3 electrically connected to the conductive terminals 2, a metal shell 4 enclosing the housing 1, a cable 5 electrically connected to the PCB 3 and an insulative cover 6 enclosing the metal shell 4.

The housing 1 comprises a main portion 10, a receiving groove 11 recessed rearwardly from a front surface thereof and a plurality of passageways 12 passed through the front and rear surface thereof. The passageways 12 are arranged in two rows and respectively located on an upper and lower wall of the housing 1, and communicated with the receiving groove 11. The housing 1 further defines a pair of extending arms 13 extending rearwardly from two laterals of the rear surface of the main portion 10. Each extending arm 13 defines a long slot 131 located on an inner surface thereof.

The PCB 3 defines a plurality of through holes 31 passed through an upper and a lower surfaces thereof. The through holes 31 are arranged in two rows, of which a row of front through holes 311 is proximate to the housing 1 and another row of rear through holes 312 is distal from the housing 1.

The conductive terminals 2 comprises a first terminal set 21 and a second terminal set 22. The first terminal set 21 is through the rear through holes 312, and the second terminal set 22 is through the front through holes 311. Each conductive terminal 2 comprises a mating portion 23 received in the receiving groove 11, a retaining portion 25 extending rearwardly from the mating portion 23 and an exposing portion 24 extending bendly from the retaining portion 25. In assembly, the exposing portion 24 is beyond out of the rear surface of the housing 1. The exposing portion 24 is bent and comprises a vertical portion 241 inserted vertically into the through hole 31, and a horizontal portion 242 extending forwardly from the vertical portion 241, and a connecting portion 243 connected horizontal portion 242 to the retaining portion 25. The vertical portion 241 is perpendicular to the horizontal portion 242. The connecting portion 243 and the horizontal portion 242 of the exposing portion 24, and the retaining portion 25 of the first terminal set 21 are a straight line. The connecting portion 243 and the horizontal portion 242 of the exposing portion 24 of the second terminal set 22 are vertical to the retaining portion 25. The connecting portion 243 of the second terminal set 22 is extending from the retaining portion 25 toward the first terminal set 21. When the distance between two rows of the mating portions 23 or/and the retaining portions 25 of the first and second terminal sets 21, 22 are constant, relative to the existing connector cable assembly, the distance between the horizontal portion 242 of the first terminal set 21 and the horizontal portion 242 of the second terminal set 22 is shorter. The distance between the PCB 3 and the horizontal portion 242 of the first terminal set 21 is shorter. So, the electrical connector assembly 100 has a smaller volume.

The metal shell 4 comprises a front shell 41 and a rear shell 42 assembled on the front shell 41. The front shell 41 and the rear shell 42 are made of metal material. The front shell 41 comprises a flat portion 411, a box 412 located on the front of the flat portion 411 and a pair of lateral walls 413 extending upwardly from the flat portion 411. Each lateral wall 413 defines a pair of rectangle through holes 4131. A retaining tab 4121 is extending upwardly from the rear end of an upper wall of the box 412. A step 4122 is located on a connection point between the rear end of a lower wall of the box 412 and the flat portion 411. The rear shell 42 has a roof portion 421 and a pair of lateral walls 422 extending downwardly from the roof portion 421. A pair of clipping tabs 4221 is defined on the lateral wall 422 for coordinating with the rectangle through holes 4131 of the lateral wall 413. The rear shell 42 further defines a holder pin 423 located on the rear of the roof portion 421.

The electrical connector assembly 100 further comprises a pair of inner molding 7 molded on the first terminal set 21 and the second terminal set 22. Each inner molding 7 defines a front portion 71 located on the front thereof and a rear portion located on the rear thereof. The front portion 71 is smaller than the rear portion 72. A pair of convexes 711 is extended outwardly from two lateral sides of the front portion 71.

In assembly, the inner molding 7 respectively encloses the retaining portions 25 of the first terminal set 21 and the second terminal set 22. The mating portions 24 and the partially retaining portion 25 are exposed out of the front end of the inner molding 7, and the exposing portions 23 are exposed out of the rear end of the inner molding 7. The inner moldings 7 are assembled in the housing 1, and the first terminal set 21 and the second terminal set 22 are inserted in to the passageways 12, the mating portions are received in the receiving groove 11 for mating to a complementary connector (not shown). The front surface of the inner moldings 7 are attached to the rear surface of the main portion 10 of the housing 1. The upper and lower surfaces of the front portion 71 of the inner molding 7 are aligning to the upper and lower surface of the housing 1. The convexes 711 of the inner molding 7 are received in the long slots 131 of the extending arms 13 to make the inner molding 7 retained in the housing 1. The rear surfaces of the extending arms 13 are attached to the front surface of the rear portion 72 of the inner molding 7. Both inner molding 7 are symmetric. The rear end surfaces of the exposing portions 241 of the first terminal set 21 and the second terminal set 22 are located on a same plane. The horizontal portion 242 of the second terminal set 22 located at the top of that of the first second terminal set 21. The first terminal set 21 partially surrounded the second terminal set 22. In other embodiments, two inner moldings7 are integrated and assembled on the housing 1.

The PCB 3 is located on the rear of the inner molding 7. The conductive terminals 2 are soldered on the PCB 3. The vertical portions 241 of the exposing portions 24 of the conductive terminals 2 are received in the through holes 31 of the PCB 3 from the lower surface to the upper surface of the PCB 3. The vertical portion 241 is vertical to the PCB 3. The surface of the horizontal portion 242 of the second terminal set 22 keeps close to the PCB 3. Between the horizontal portion 242 of the first terminal set 21 and the PCB 3 are a distance. The cable 6 is soldered on the PCB 3.

The housing 1 is received in the box 412, and the front portion 71 of the inner molding 7 is received in the box 412. The housing 1 and the box 412 are interfered to each other. Both the inner moldings 7 and the box 412 are interfered to each other. The front surface of the rear portion 72 of the inner molding 7 is attached to the step 4122 and the retaining tab 4121 of the front shell 41. The rear shell 42 is assembled on the front shell 41. The clipping tabs 4221 of the lateral wall 422 are clipped in the rectangle through holes 4131. The inner front surface of rear shell 42 is attached to the retaining tab 4121. The rear portion 72 of the inner molding 7 and the PCB 3 is received in the metal shell 4. The holder pin 423 of the metal shell 4 holds the cable 5. The insulative cover 6 is molded on and encloses partially the metal shell 4. The insulative cover 6 also encloses the cable 5.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electrical connector assembly, comprising:
a housing;
a plurality of conductive terminals received in the housing and arranged in two rows, each conductive terminal defining a front mating portion, a retaining portion retained in the housing, and an exposing portion located behind the housing;
a PCB electrically connected to the conductive terminals and having a number of through holes through an upper and a lower surfaces thereof; and
a metal shell enclosing the housing and the PCB;
wherein at least a row of conductive terminals are bent and pass through the through holes, and two rows of exposing portions of the conductive terminals are soldered on a surface of the PCB.

2. The electrical connector assembly as recited in claim 1, wherein the conductive terminals define a row of first terminal set and another row of second terminal set.

3. The electrical connector assembly as recited in claim 2, wherein the through holes comprises a row of front through holes proximate to the housing and a row of rear through holes distal from the housing.

4. The electrical connector assembly as recited in claim 3, wherein the exposing portions of the first terminal set pass through the rear through holes, and that of the second terminal set pass through the front through holes.

5. The electrical connector assembly as recited in claim 4, wherein the exposing portion of the conductive terminal comprises a vertical portion inserted into the through hole and a horizontal portion extending forwardly from the vertical portion and perpendicular to the vertical portion.

6. The electrical connector assembly as recited in claim 5, wherein the horizontal portions of the second terminal set and the first terminal set are arranged in the upper and lower rows.

7. The electrical connector assembly as recited in claim 6, wherein the vertical portion of the first terminal set is inserted into the rear through holes, and that of the second terminal set is inserted into the front through holes.

8. The electrical connector assembly as recited in claim 7, wherein the surfaces of the horizontal portions of the second terminal set are kept close to the PCB.

9. The electrical connector assembly as recited in claim 8, wherein the exposing portion further comprises a connecting portion connected the horizontal portion to the retaining portion.

10. The electrical connector assembly as recited in claim 9, wherein the connecting portion of the second terminal set is perpendicular to the retaining portion, and the horizontal portion, the connecting potion and the retaining portion of the first terminal set are a straight line.

11. The electrical connector assembly as recited in claim 1, wherein the electrical connector assembly further comprises an inner molding molded on the conductive terminals and assembled behind the housing.

12. An electrical connector assembly, comprising:
a housing having an upper wall and a lower wall opposite to the upper wall;
a row of first terminal set located in the lower wall;
a row of second terminal set located in the upper wall; and
a PCB having an upper surface, a lower surface, and a number of through holes through the upper and lower surface; the upper and lower surface extending along a mating direction of the electrical connector assembly;
wherein all the first and second terminal sets define a number of exposing portions located behind the housing and soldered on the upper or lower surface of the PCB, at least one terminal set received in holes through.

13. The electrical connector assembly as recited in claim 12, wherein the exposing portion of the second terminal set define a vertical portion passed through the through hole, a horizontal portion vertical the vertical portion and a connecting portion parallel to the vertical portion and located on the front of the PCB.

14. The electrical connector assembly as recited in claim 12, wherein the exposing portion of the first terminal set defines a vertical portion passed through the through hole, a horizontal portion perpendicular to the vertical portion and a connecting portion extending forwardly toward the housing.

15. The electrical connector assembly as recited in claim 12, wherein the through holes define a front through hole proximate to the housing and a rear through hole distal from the housing.

16. The electrical connector assembly as recited in claim 15, the exposing portion of the first terminal set is received in the rear through hole, and that of the second terminal set is received in the front through hole.

17. An electrical connector assembly comprising:
an insulative housing defining therein two rows of passageways in a transverse direction under condition that each of said passageways extends in a front-to-back direction perpendicular to said transverse direction;
a pair of terminal modules stacked with each other in a vertical direction perpendicular to both said transverse direction and said front-to-back direction, each of said terminal modules defining a row of terminals bound in an insulator with front contacting sections extending into a corresponding one of said two rows of passageways, respectively, and rear soldering sections exposed outside of the insulator; and
a printed circuit board positioned behind the housing and lying in a plane defining by said transverse direction and said front-to-back direction at a level essentially around an interface of said stacked terminal modules in the vertical direction; wherein
the soldering tails of one of the pair of the terminal modules extend toward the other of the pair of terminal modules so as to join those of the other of the pair of the terminal modules to commonly approach a same surface of said printed circuit board for securing said soldering tails to the printed circuit board.

18. The electrical connector assembly as claimed in claim 17, wherein the soldering tails of said one of the pair terminal modules extend in the vertical direction toward the other of the pair of terminal modules.

19. The electrical connector assembly as claimed in claim 18, wherein portions of the soldering tails of said one of the pair of terminal modules extending in the vertical direction toward the other, abut against rear faces of the insulators of both said pair of terminal modules for supporting consideration.

20. The electrical connector assembly as claimed 17, wherein the soldering tails of the terminals of both said pair of terminal modules are of a through hole type to connect to the printed circuit board.
